(19) United States
(12) Patent Application Publication
(10) Pub. No.: US 2024/0202527 A1
(43) Pub. Date: Jun. 20, 2024

(54) METHOD AND APPARATUS WITH NEURAL NETWORK OPTIMIZATION

(71) Applicants: SAMSUNG ELECTRONICS CO., LTD., Suwon-si (KR); Seoul National University R&DB Foundation, Seoul (KR)

(72) Inventors: Seok-Young YOON, Suwon-si (KR); Bernhard EGGER, Seoul (KR); Hyemi MIN, Seoul (KR); Jaume Mateu CUADRAT, Seoul (KR)

(73) Assignees: SAMSUNG ELECTRONICS CO., LTD., Suwon-si (KR); Seoul National University R&DB Foundation, Seoul (KR)

(21) Appl. No.: 18/353,432

(22) Filed: Jul. 17, 2023

(30) Foreign Application Priority Data
Dec. 15, 2022 (KR) 10-2022-0176169

(51) Int. Cl. G06N 3/082; G06N 3/04

(52) U.S. Cl. CPC G06N 3/082; G06N 3/04

(57) ABSTRACT

A method of processing data is performed by a computing device including processing hardware and storage hardware, the method including: converting, by the processing hardware, a neural network, stored in the storage hardware, from a first neural network format into a second neural network format; obtaining, by the processing hardware, information about hardware configured to perform a neural network operation for the neural network and obtaining partition information; dividing the neural network in the second neural network format into partitions, wherein the dividing is based on the information about the hardware and the partition information, wherein each partition includes a respective layer with an input thereto and an output thereof; optimizing each of the partitions based on a relationship between the input and the output of the corresponding layer; and converting the optimized partitions into the first neural network format.

### CROSS-REFERENCE TO RELATED APPLICATIONS

This application claims the benefit under 35 USC § 119(a) of Korean Patent Application No. 10-2022-0176169, filed on Dec. 15, 2022, in the Korean Intellectual Property Office, the entire disclosure of which is incorporated herein by reference for all purposes.

### BACKGROUND

### 1. Field

The following description relates to a method and an apparatus with neural network optimization, and more particularly, to optimizing a neural network by dividing the neural network into partitions.

### 2. Description of Related Art

Modern multi-core devices may search for data partitions in batch and channel directions. Modern compilers may implement graph partitioner operators using open-source frameworks. Graph compilers for multiple devices may usually allocate small sections of the entire graph to different devices or divide the total number of batches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of processing data is performed by a computing device including processing hardware and storage hardware, the method including: converting, by the processing hardware, a neural network, stored in the storage hardware, from a first neural network format into a second neural network format; obtaining, by the processing hardware, information about hardware configured to perform a neural network operation for the neural network and obtaining partition information; dividing the neural network in the second neural network format into partitions, wherein the dividing is based on the information about the hardware and the partition information, wherein each partition includes a respective layer with an input thereto and an output thereof; optimizing each of the partitions based on a relationship between the input and the output of the corresponding layer; and converting the optimized partitions into the first neural network format.

The partition information may include data division direction information, the dividing of the neural network in the second format is based on the data division direction information, and the data division direction information may include a height direction of the data, a width direction of the data, or a channel direction of the data.

The information about the hardware may include a number of elements of the hardware, and the dividing of the neural network may include: determining a number of partitions to be formed based on the number of the hardware; and dividing the neural network in the second format into the partitions based on the determined number of partitions to be formed.

The optimizing of the partitions may include removing an operator that satisfies a predetermined condition among operators included in each of the partitions.

The optimizing of the partitions may include determining whether to remove a crop operator or a concat operator among operators included in the partitions.

For one of the layers, the optimizing of the partitions may include adjusting a size of the output of the one layer to correspond to a size of the input of the one layer by adding a dependent operator to the output of the one layer in response to the size of the one output of the layer being less than the size of the input of the one layer.

The optimizing of the partitions may include removing the crop operator and the concat operator in response to the size of the output of the one layer being the same as the size of the input of the one layer.

The optimizing of the partitions may include removing the concat operator in response to the size of the output of the one layer being greater than the size of the input of the one layer.

The converting of the optimized partitions into the first neural network format may be based on information corresponding to a weight dimension, an operator type, and/or a size of a feature of the neural network.

The converting of the optimized partitions into the first neural network format may include adding a real-time operator for synchronization between the optimized partitions in the first neural network format when executed by the hardware.

The dividing of the neural network may include converting the partitions into multi-directional division partitions by setting a data division direction to multiple directions.

The dividing of the neural network may include generating an intermediate data transmission division partition in a data division direction using multiple directions and multiple layers.

In one general aspect, an apparatus includes one or more processors and memory storing instructions configured to cause the one or more processors to perform a process including: accessing a neural network in a second neural network format; obtaining information about hardware for performing a neural network operation and partition information and divide the neural network in the second neural network format into partitions, wherein the dividing is based on the information about the hardware and the partition information; optimizing the partitions based on a relationships between an inputs and corresponding outputs of layers included in the partitions; converting the plurality of optimized partitions into a first neural network format; and executing the optimized partitions in the first neural network format by the hardware.

The partition information may include data division direction information, the dividing the neural network in the second neural network format into the partitions is based on the data division direction information, and wherein the data division direction information may include a height direction of the data, a width direction of the data, or a channel direction of the data.

The information about the hardware may include a number of elements of the hardware, and the partitioning may include determining a number of partitions to be formed based on the number of elements of the hardware and divide the neural network in the second neural network format into the partitions based on the determined number of partitions to be formed.

The optimizing may include removing an operator that satisfies a predetermined condition among operators included in each of the partitions.

The optimizing may include determining whether to remove a crop operator or a concat operator among operators included in each of the plurality of partitions.

The optimizing may include adjusting a size of the output of one of the layers to correspond to a size of the input of the one layer by adding a dependent operator, and the adjusting may be performed in response to the size of the output of the layer being smaller than the size of the input of the layer.

The optimizing may include removing the crop operator and the concat operator in response to the size of the output of the layer being the same as the size of the input of the layer.

The optimizing may include removing the concat operator in response to the size of the output of the layer being greater than the size of the input of the layer.

Other features and aspects will be apparent from the following detailed description, the drawings, and the claims.

### BRIEF DESCRIPTION OF THE DRAWINGS

FIG. 1 illustrates an example apparatus for optimizing a neural network, according to one or more example embodiments.

FIG. 2 illustrates an example operation of a neural network apparatus, according to one or more example embodiments.

FIG. 3A illustrates an example of a layer partition generation, according to one or more example embodiments.

FIG. 3B illustrates an example of layer partitions, according to one or more example embodiments.

FIGS. 4A to 4D illustrate examples of a layer partition optimization, according to one or more example embodiments.

FIG. 5 illustrates an example of a multi-directional partition, according to one or more example embodiments.

FIG. 6 illustrates an example of an intermediate multi-directional partition, according to one or more example embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

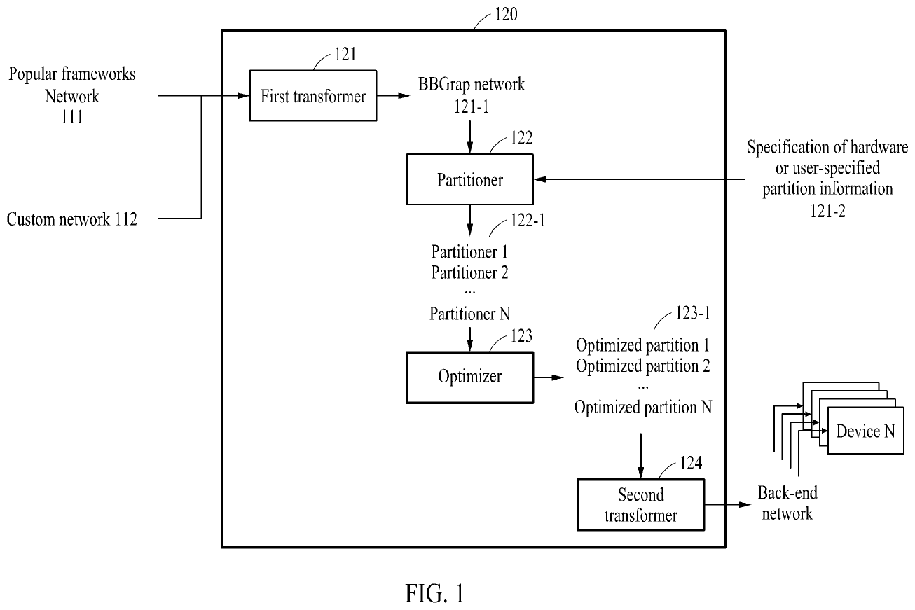

FIG. 1 illustrates an example of an apparatus for optimizing a neural network, according to one or more example embodiments.

In FIG. 1, one or more blocks and a combination thereof may be implemented by a special-purpose hardware-based computer that performs a predetermined function (e.g., a multiply and accumulate function), or a combination of computer instructions and special-purpose hardware.

A neural network optimization apparatus 120 may receive a popular frameworks network 111 (e.g., tensor flow and PyTorch) and/or a custom network 112, which will be referred to as the input or source network, and which may have a source network format. The neural network optimization apparatus 120 may convert the input network into a network optimized for a particular device (e.g., multi-core devices, such as a central processing unit (CPU), a graphics processing unit (GPU), a field programmable gate array (FPGA), and the like). The converting the input network into a network optimized for a particular device may involve using a graph partitioner (e.g., a BlackBox Graph partitioner (BBGrap)).

The neural network optimization apparatus 120 may include a first transformer 121, a partitioner 122, an optimizer 123, and a second transformer 124.

The first transformer 121 may receive the input network and may convert the input network into a predetermined-format network 121-1. Hereinafter, the predetermined-format network 121-1 may be referred to as a BBGrap-format network. The first transformer 121 may convert operators of the input network into operators of the BBGrap-format network 121-1, using only basic/innate information (e.g., type sizes of operators of a weight/a feature map) of the input network. When the input network received by the neural network optimization apparatus 120 is already in the BBGrap-format, conversion of the first transformer 121 may be bypassed and the input network may be inputted to the partitioner 122.

The partitioner 122 may obtain the BBGrap-format network 121-1 and specifications of hardware and/or user-specified partition information 121-2 and based thereon may divide the BBGrap-format network 121-1 into partitions 122-1 (e.g., partition 1, partition 2, . . . , and partition N). The dividing may be along a channel direction, a height direction, or a width direction of the BBGrap-format network 121-1. The partitioner 122 may determine the number of partitions to be formed according to the specification of hardware, e.g., the specification of hardware may specify a number of cores in a multi-core device, or a number of multi-core devices, or more generally, depending on the specification of hardware, a number of nodes. The partitioner 122 may allocate the same work speed to each of the partitions, which may also be based on the specification of hardware. Alternatively, when a user creates a user-specified partition, the partitioner 122 may divide the BBGrap network 121-1 into user-specified partitions using an operator selected by the user.

The optimizer 123 may receive the partitions 122-1 and individually optimize each of the partitions 122-1. The optimizer 123 may remove a redundant operator. The optimizer 123 may fuse layers in a partition such that synchronization between devices will not be required to execute the partition. The optimizer 123 may reduce the amount of memory to be synchronized between devices (i.e. may reduce the number/size of inter-device data requests). The optimizer 123 may generate optimized partitions 123-1 (e.g., optimized partition 1, optimized partition 2, . . . , and optimized partition N) of the respective partitions 122-1 through the process described above.

The second transformer 124 may receive the optimized partitions 123-1 and may convert the optimized partitions 123-1 to the source/original network format of the input network. A network in the original network format generated by the second transformer 124 may be applied to a multi-core device (e.g., one of Device1 to DeviceN). The second transformer 124 may add a synchronization operator during transformation based on a synchronization request generated by the neural network optimization apparatus 120 while dividing the BBGrap network 121-1.

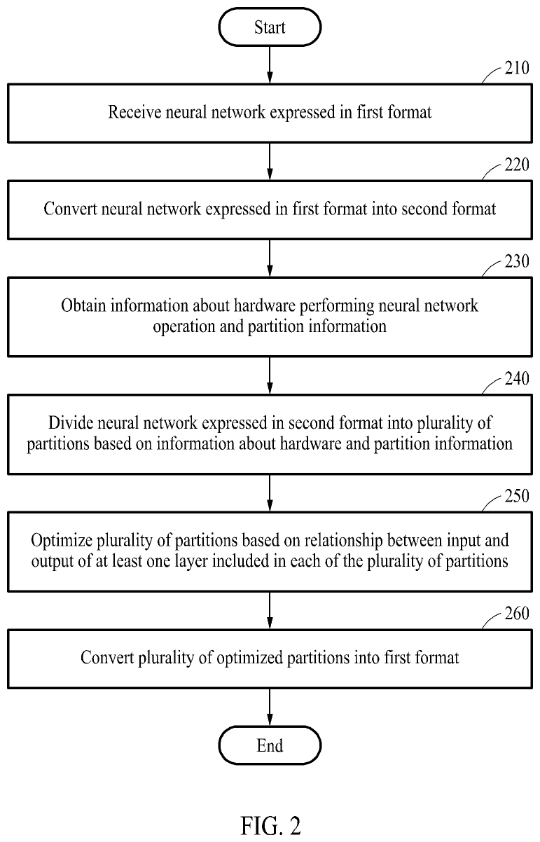

FIG. 2 illustrates an example of an operation of a neural network apparatus, according to one or more example embodiments.

The description of FIG. 1 may generally apply to the description of FIG. 2.

For convenience of description, operations 210 to 260 may be described as being performed using the neural network optimization apparatus 120 shown in FIG. 1. However, operations 210 to 260 may be performed by another suitable electronic device in a suitable system.

In operation 210, the neural network optimization apparatus 120 may receive a neural network expressed in a source/first format (e.g., the popular frameworks network 111 or the custom network 112 of FIG. 1).

In operation 220, the neural network optimization apparatus 120 may convert the neural network expressed in the first format into a second format (e.g., the BBGrap-format network 121-1 of FIG. 1). The neural network optimization apparatus 120 may convert the neural network expressed in the first format into the second format based on information corresponding to the weight (dimension), operator type, and/or the size of a feature map of the neural network.

Operation 220 may include the first transformer 121 converting an operator of the first format into another operator of the second format. The first transformer 121 may convert the operator of the first format into the operator of the second format using a weight or various input feature maps. When the first transformer 121 performs the transformation (inside the created LayerWrapper, discussed below), it may also store the number of cores (or nodes) that will be used to do the division of the partitioner 122. That information will create the layers 321 to 324.

In operation 230, the neural network optimization apparatus 120 may obtain (i) information about hardware to be used to perform a neural network operation (on the partitions after conversion to the first/source format) and (ii) partition information (e.g., the specifications of the hardware or the user-specified partition information 121-2 of FIG).

The partition information may include direction information for data division. The data division direction information may indicate a height direction, a width direction, or a channel direction.

The information about the hardware may indicate a number of hardware elements, e.g., the number of multi-core devices and/or the number of cores of the multi-core devices; in some cases the number of hardware elements could refer to multiple devices (a high level division), and in other cases (e.g., one device with multiple cores) it could refer to a more specific hardware division (low level division)

In operation 240, the neural network optimization apparatus 120 may divide the neural network expressed in the second format into the partitions based on the information of the hardware and the partition information.

The partitioner 122 may divide the neural network expressed in the second format into the partitions based on the data division direction information. The partitioner 122 may determine the number of partitions (the number N of partitions) into which the neural network in the second format is to be divided based on the number of hardware elements (e.g., a number of multi-core devices, a number of accelerators, etc.). The neural network expressed in the second format may be divided into partitions (e.g., the partitions 122-1 of FIG. 1) based on the determined number of partitions.

The partitioner 122 may divide the neural network into partitions considering a limitation of a compiler. For example, the partitioner 122 may divide the neural network into data partitions across the width direction or divide the neural network into linear operator model partitions (e.g., MaxPool or linear convolution, etc.). For dividing, the partitioner 122 may use information of a LayerWrapper level that already includes information (e.g., the number of cores used in a network layer and operator information of the first format) sufficient for the dividing.

In operation 250, the neural network optimization apparatus 120 may optimize the partitions 122-1 based on a relationship between an input and an output of a layer included in a partitions 122-1. Optimization may be based on such relationships for multiple layers of a partition 122-1 and/or for multiple partitions 122-1.

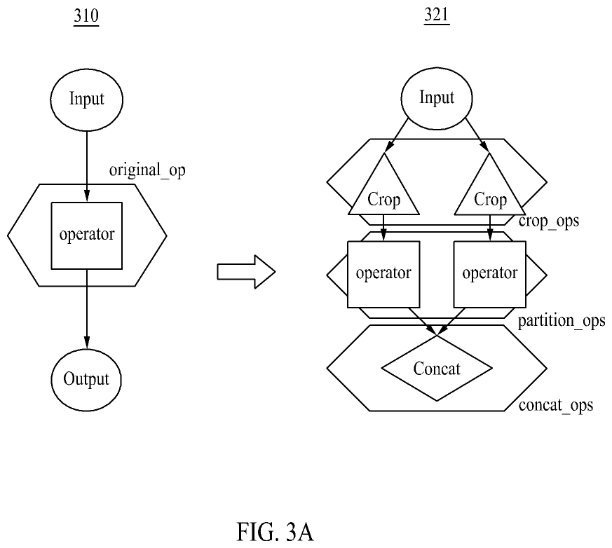

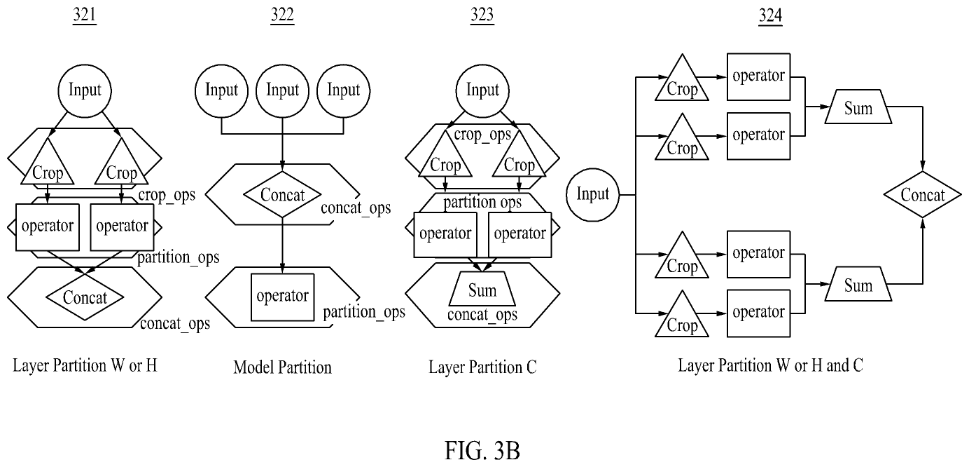

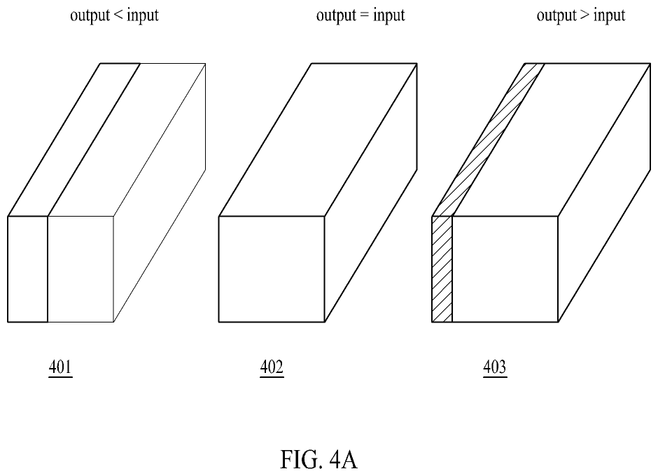

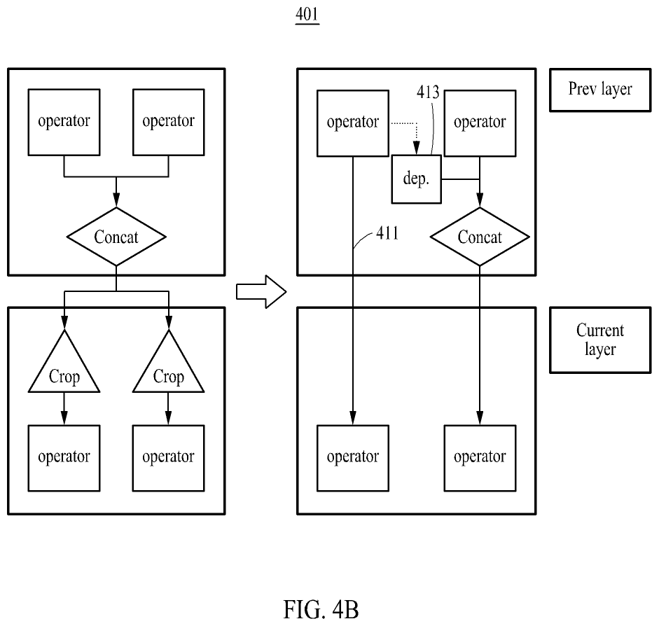

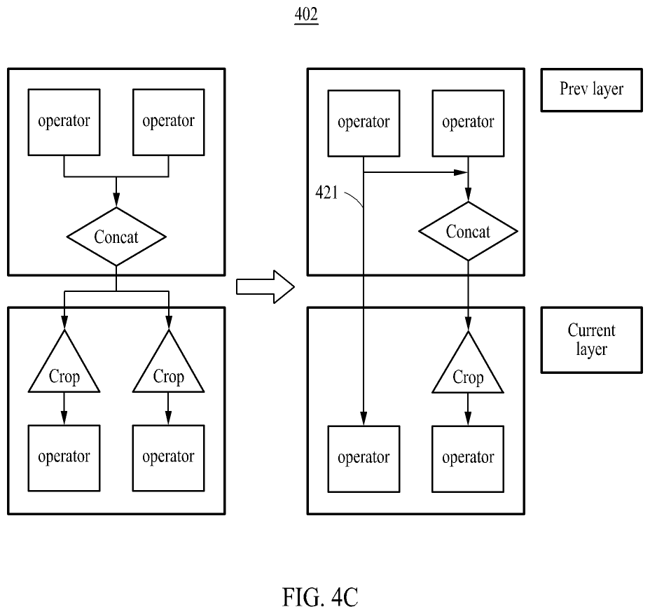

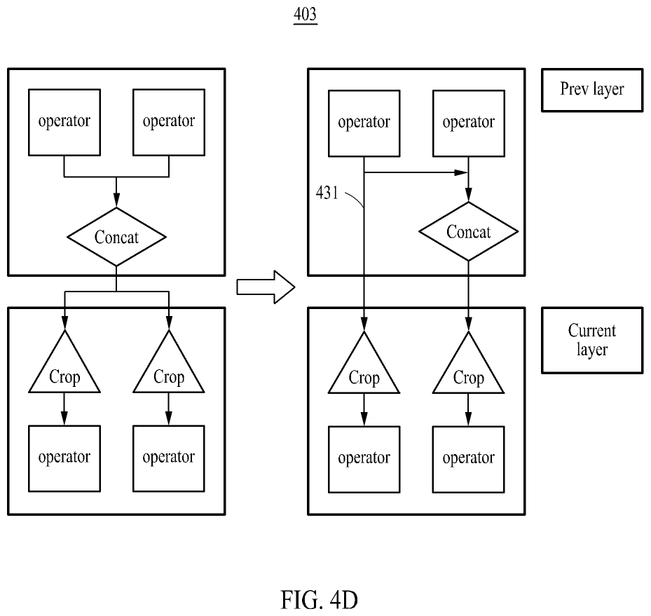

The optimizer 123 may remove an operator that satisfies a predetermined condition among operators included in each of the partitions 122-1. The optimizer 123 may determine whether to remove a crop operator or a concat operator from among operators included in the partitions 122-1. An optimization operation performed by the optimizer 123 is described with reference to FIG. 3A and FIGS. 4A to 4D.

In operation 260, the neural network optimization apparatus 120 may convert the optimized partitions 123-1 into partitions having the first format. A real-time operator for inter-partition synchronization may be added to the optimized partitions 123-1.

The second transformer 124 may perform a post-processing operation and may apply the optimized partitions 123-1 converted into the first format to a device.

FIG. 3A illustrates an example of a layer partition generation, according to one or more embodiments.

FIG. 3B illustrates an example of layer partitions, according to one or more example embodiments.

The description provided with reference to FIGS. 1 and 2 may be generally applicable to the example of FIGS. 3A and 3B.

Referring to FIG. 3A, the partitioner 122 may obtain/form a layer 321 (which includes a data operator) by dividing an original layer 310 (which includes an original data operator ‘original_op’ of the BBGrap network 121-1), and the dividing may be based on the information regarding the LayerWrapper level, the crop operator, and the concat operator. To elaborate, the division may be performed by the LayerWrapper (inside the partitioner), but the division may be specific to the type of the operator. For example, a division of a “sum” operator (which does not have a kernel) may differ from a division of a “conv” operator (which has a kernel). The concat operator may concatenate results from a division (split) of an operator in a layer partition. When hardware for executing the layer has two cores, partitions generated through the same number of operators using the crop operator may generate a symmetric result.

Referring to FIG. 3B, the partitioner 122 may obtain layer partitions 321 to 324 (which include the data operator) by dividing the original layer 310 (which includes the original data operator of the BBGrap network 121-1) in the direction at least one of the channel direction, the height direction, or the width direction. The layer 321 may be generated when the hardware has two cores and the layer 324 may be generated when the hardware has four cores.

A first layer partition 321 may be generated when the partitioner 122 divides the original layer 310 in the width direction W or the height direction H. A second layer partition 322 may be generated when the partitioner 122 divides the original layer 310 according to a linear operator (fully connected layer) of the original layer 310 and may be referred to as a model partition (this type of operator cannot be easily divided in some directions, so model division may be used). A third layer partition 323 may be generated when the partitioner 122 divides the original layer 310 in the channel direction C. A fourth layer partition 324 may be generated when the partitioner 122 divides the original layer 310 twice in the width direction, the height direction, or the channel direction. embodiment are described herein mainly with reference to an example where the number of hardware cores (e.g., in one device) is two and the number of partitions is not limited to two.

FIGS. 4A to 4D illustrate examples of a layer partition optimization, according to one or more example embodiments.

The description of FIG. 1 to FIGS. 3A and 3B is generally applicable to the example of FIGS. 4A to 4D.

In operation 250, the optimizer 123 may optimize the partitions 122-1. A given partition 122-1 may be optimized based on the relationship between the input and the output of at least one layer included in the given partition 122-1. This optimizing may be done for layers of other partitions.

To optimize a partition, the optimizer 123 may reduce the number of redundant operators. The optimizer 123 may delete redundant operators so that redundant operators (e.g., the concat operator and the crop operator) become unique operators. The optimizer 123 may compare an output of a layer partition to an input of a next layer partition.

Referring to FIGS. 4A and 4B, in a case 401 where an output of a layer is smaller than an input of a next layer, the optimizer 123 may adjust an output size of the layer to correspond to an input size of the next layer by adding a dependent operator 413. The optimizer 123 may add the dependent operator 413 to a previous layer (any layer producing output can serve as an input to the current layer) to add missing information to a layer output, and may add the dependent operator 413 according to an operator of a next layer and a concat for an output of a previous layer. An output of a layer that passes through the dependent operator 413 may have the same size as an input of a next operator. When a concat output of the layer is the same as the input of the next layer, the crop operator may be removed as indicated by reference numeral 411 (FIG. 4B).

Referring to FIGS. 4A and 4C, the optimizer 123 may remove the crop operator and the concat operator in a case 402 where the output size of the layer and the input size of the next layer are the same. When the output size of the layer and the input size of the next layer are the same, there is no need to reduce the output size of the layer, so the optimizer 123 may remove a redundant crop operator and a redundant concat operator as indicated by reference numeral 421.

Referring to FIGS. 4A and 4D, the optimizer 123 may remove the concat operator in a case 403 where the output size of the layer is greater than the input size of the next layer. When the output size of the layer is greater than the input size of the next layer, the output of the layer may be cropped through the crop operator directly to match the input size of the next layer, so the concat operator may be removed as indicated by reference numeral 431.

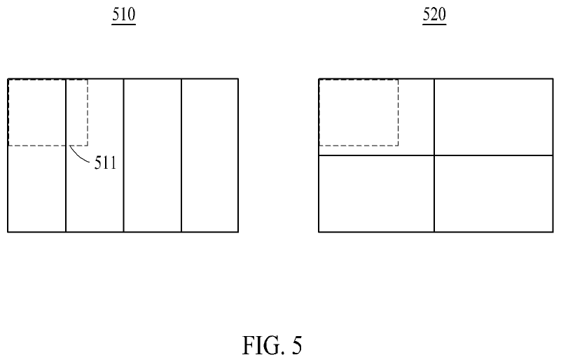

FIG. 5 illustrates an example of a multi-directional partition.

The description provided with reference to FIG. 1 to FIGS. 4A to 4D is generally applicable to the example of FIG. 5.

Referring to FIG. 5, before optimization, the partitioner 122 may convert the partitions 122-1 into multi-directional division partitions 520 by setting the data division direction in multiple directions when a kernel is larger than the size of each of the plurality of partitions 122-1. For example, in the case of width-directional division partitions 510, when the width of a kernel 511 is greater than the width of each of the divided partitions, the partitioner 122 may generate the multi-directional division partitions 520 using both the width-directional division and the height-directional division in dividing of the neural network through the kernel 511. To generate one output, a partition having a size corresponding to the size of the kernel 511 may be required. When the width of the partition is less than the size of the kernel 511 and a memory is limited, the partitioner 122 may increase the width of the partition by dividing the height direction of the partition through a multi-directional partition division.

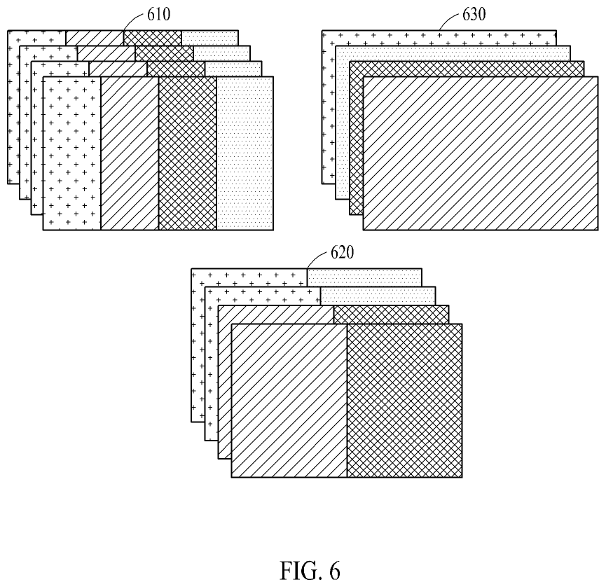

FIG. 6 illustrates an example of an intermediate multi-directional partition, according to one or more example embodiments.

The description provided with reference to FIG. 1 to FIGS. 4A to 4D is generally applicable to the example of FIG. 6.

Referring to FIG. 6, the partitioner 122 may generate an intermediate data transmission division partition in the data division direction using multiple directions and multiple layers. The partitioner 122 may determine an efficient division direction and size of the partition according to features of the corresponding layer in a multi-layered network.

Referring to an example 610 of a layer division, when the size of a feature map is greater than the size of a weight, dividing the partition in the width direction or the height direction of the feature map may be effective.

Referring to an example 620 of a layer division, when the size of the feature map and the size of the weight do not differ greatly and are not biased, dividing the partition in multiple directions including the width direction, the height direction, and the channel direction may be effective.

Referring to an example 630 of a layer division, when the size of the feature map is smaller than the size of the weight, dividing the partition in an input channel direction may be effective. That is, dividing of the partition in only one direction may be effective.

The computing apparatuses, the electronic devices, the processors, the memories, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of processing data performed by a computing device comprising processing hardware and storage hardware, the method comprising:
converting, by the processing hardware, a neural network, stored in the storage hardware, from a first neural network format into a second neural network format;
obtaining, by the processing hardware, information about hardware configured to perform a neural network operation for the neural network and obtaining partition information;
dividing the neural network in the second neural network format into partitions, wherein the dividing is based on the information about the hardware and the partition information, wherein each partition comprises a respective layer with an input thereto and an output thereof;
optimizing each of the partitions based on a relationship between the input and the output of the corresponding layer; and
converting the optimized partitions into the first neural network format.

2. The method of claim 1, wherein
the partition information comprises data division direction information,
the dividing of the neural network in the second format is based on the data division direction information, and
the data division direction information comprises a height direction of the data, a width direction of the data, or a channel direction of the data.

3. The method of claim 1, wherein
the information about the hardware comprises a number of elements of the hardware, and
the dividing of the neural network comprises:
determining a number of partitions to be formed based on the number of the hardware; and
dividing the neural network in the second format into the partitions based on the determined number of partitions to be formed.

4. The method of claim 1, wherein the optimizing of the partitions comprises removing an operator that satisfies a predetermined condition among operators comprised in each of the partitions.

5. The method of claim 1, wherein the optimizing of the partitions comprises determining whether to remove a crop operator or a concat operator among operators comprised in the partitions.

6. The method of claim 5, wherein, for one of the layers, the optimizing of the partitions comprises adjusting a size of the output of the one layer to correspond to a size of the input of the one layer by adding a dependent operator to the output of the one layer in response to the size of the one output of the layer being less than the size of the input of the one layer.

7. The method of claim 5, wherein the optimizing of the partitions comprises removing the crop operator and the concat operator in response to the size of the output of the one layer being the same as the size of the input of the one layer.

8. The method of claim 5, wherein the optimizing of the partitions comprises removing the concat operator in response to the size of the output of the one layer being greater than the size of the input of the one layer.

9. The method of claim 1, wherein the converting of the optimized partitions into the first neural network format is based on information corresponding to a weight dimension, an operator type, and/or a size of a feature of the neural network.

10. The method of claim 1, wherein the converting of the optimized partitions into the first neural network format comprises adding a real-time operator for synchronization between the optimized partitions in the first neural network format when executed by the hardware.

11. The method of claim 2, wherein the dividing of the neural network comprises converting the partitions into multi-directional division partitions by setting a data division direction to multiple directions.

12. The method of claim 2, wherein the dividing of the neural network comprises generating an intermediate data transmission division partition in a data division direction using multiple directions and multiple layers.

13. An apparatus comprising:
one or more processors;
memory storing instructions configured to cause the one or more processors to perform a process comprising:
accessing a neural network in a second neural network format;
obtaining information about hardware for performing a neural network operation and partition information and divide the neural network in the second neural network format into partitions, wherein the dividing is based on the information about the hardware and the partition information;
optimizing the partitions based on a relationships between an inputs and corresponding outputs of layers comprised in the partitions;
converting the plurality of optimized partitions into a first neural network format; and
executing the optimized partitions in the first neural network format by the hardware.

14. The apparatus of claim 13, wherein
the partition information comprises data division direction information,
the dividing the neural network in the second neural network format into the partitions is based on the data division direction information, and
wherein the data division direction information comprises a height direction of the data, a width direction of the data, or a channel direction of the data.

15. The apparatus of claim 13, wherein
the information about the hardware comprises a number of elements of the hardware, and
the partitioning comprises determining a number of partitions to be formed based on the number of elements of the hardware and divide the neural network in the second neural network format into the partitions based on the determined number of partitions to be formed.

16. The apparatus of claim 13, wherein the optimizing comprises removing an operator that satisfies a predetermined condition among operators comprised in each of the partitions.

17. The apparatus of claim 13, wherein the optimizing comprises determining whether to remove a crop operator or a concat operator among operators comprised in each of the plurality of partitions.

18. The apparatus of claim 17, wherein the optimizing comprises adjusting a size of the output of one of the layers to correspond to a size of the input of the one layer by adding a dependent operator, wherein the adjusting is performed in response to the size of the output of the layer being smaller than the size of the input of the layer.

19. The apparatus of claim 17, wherein the optimizing comprises removing the crop operator and the concat operator in response to the size of the output of the layer being the same as the size of the input of the layer.

20. The apparatus of claim 17, wherein the optimizing comprises removing the concat operator in response to the size of the output of the layer being greater than the size of the input of the layer.
